(19) United States
(12) Patent Application Publication
(10) Pub. No.: US 2013/0176146 A1
(43) Pub. Date: Jul. 11, 2013

(54) Decentralised Autonomic System and Method for Use in an Urban Traffic Control Environment

(71) Applicants: Ivana Dusparic, Dublin (IE); Vincent Cahill, Dublin (IE)

(72) Inventors: Ivana Dusparic, Dublin (IE); Vincent Cahill, Dublin (IE)

(73) Assignee: THE PROVOST, FELLOWS AND SCHOLARS OF THE COLLEGE OF THE HOLY & UNDIVIDED TRINITY OF QUEEN ELIZABETH, Dublin (IE)

(21) Appl. No.: 13/703,774

(22) PCT Filed: Jun. 15, 2011
(86) PCT No.: PCT/EP11/59926

§ 371 Date: Mar. 29, 2013

Related U.S. Application Data
(60) Provisional application No. 61/354,798, filed on Jun. 15, 2010.

(30) Foreign Application Priority Data
Jun. 15, 2010 (EP) 1009974.5

(51) Int. Cl. G08G 1/07

(52) U.S. Cl. CPC G08G 1/07
USPC 340/907

(57) ABSTRACT

The invention provides a system of agents for use in an Urban Traffic Control environment, each agent representing a traffic light controller at a traffic junction to control traffic flow, said system comprising each agent is adapted to collect data local to the junction using one or more sensors and applying a Distributed W-Learning model to said collected data; each agent comprises means for mapping locally collected data to one of the system state representations available to determine action values; each agent is adapted to determine a current importance value of an action value using a Distributed W-Learning model. The main operational advantage of the system of the invention is that it utilizes machine learning to learn appropriate behaviours for a variety of traffic conditions, in a fully decentralized distributed self-organizing approach capable of addressing multiple performance policies on multiple agents, where data collection and analysis is performed by the junctions or intersections locally.

### FIELD OF THE INVENTION

The invention relates to the field of decentralized autonomic systems, and specifically to urban traffic control systems.

### BACKGROUND TO THE INVENTION

Existing Urban Traffic Control (UTC) approaches fall into two main categories: fixed-time and adaptive traffic controllers. In fixed-time systems, selection of traffic light sequences and their duration is designed offline using specialized programs such as TRANSIT (TRL, Transit Research Lab in the UK) and MAXBAND (US Department of Transport). Such UTC systems usually consist of several different fixed-time plans designed for morning peak, midday, afternoon peak, and evening/night-time conditions. In addition, special plans may be produced, for example, for recurring major music or sporting events. The major disadvantage of fixed-time plans is that they are rarely kept up to date due to the complexity and duration of the design process for the new plans and that they are not able to deal well with fluctuations in the patterns.

Widely deployed adaptive traffic control techniques include UTMC (Federal Highway Administration USA), SCATS (Roads and Traffic Authority of New South Wales, Australia) and SCOOT (Transport and Road Research Laboratory UK, Siemens Traffic Control, Peek Traffic). UTMC initially used fixed-time offline design, but later versions use on-line comparison of traffic data and historical data to re-evaluate the current plan every 15 minutes.

SCATS and SCOOT also provide online adaptation with signal duration being adjusted at every cycle. Both approaches primarily rely on the use of induction loops to estimate traffic counts and adjust the duration of the signal accordingly, showing significant improvements over fixed-time controllers. The main disadvantages of these systems are their centralized or hierarchical control, which limits the amount of data that can be processed in real-time, in turn limiting the accuracy of adaptation, as well as reliance on expensive to install and maintain induction loops. These systems also require significant manual pre-configuration (i.e. selecting the traffic phases to be deployed, grouping junctions into subsystems etc.) as well as significant expertise and cost to configure and operate.

There are also a number of prototype UTC systems currently being tested that aim to provide more reactive real-time adaptivity. The most significant of those are RHODES (University of Arizona), OPAC (University of Massachusetts) and RTACL (University of Pittsburgh/University of Maryland). OPAC and RHODES attempt to predict future traffic conditions at the intersection and network level, and show some improvements in prototype testing over existing strategies, however there are concerns about their applicability being limited only to main arteries in undersaturated conditions. RTACL uses distributed control where most decision making is done at the local level and by communicating with neighbouring intersections, however, in field tests RTACL shows inconsistencies in performance by improving travel times along certain routes, while significantly degrading the service on others.

Numerous scientific works also address the issue of UTC using various multi-agent and learning techniques. In a paper published by Bazzan, A. L. (2005). “A distributed approach for coordination of traffic signal agents”, Autonomous Agents and Multi-Agent Systems, 10 (1), 131-164, evolutionary game theory is used to model individual traffic controllers as agents that are capable of sensing their local environment and learning optimal parameters for continually changing traffic patterns. Agents receive both local reinforcement from their local detectors, and global reinforcement based on global traffic conditions. For example, if the majority of traffic travels westbound, agents receive higher payoffs for giving longer green signals to that direction. Global matrices of payoffs need to be specified by the designer of the system for each set of traffic conditions and as such require domain knowledge to construct. This work does not address multiple traffic policies but only optimizing global traffic flow, and does not learn the dependencies between agents' performances.

In another published paper by Febbraro et al. (2004) Febbraro, A. D., Giglio, D., & Sacco, N. (2004). “Urban traffic control structure based on hybrid Petri nets”, IEEE Transactions on Intelligent Transportation Systems, 5 (4), 224-237, Petri nets are used to model each junction in a simulation of a UTC system, representing vehicle flows entering the junction, leaving the junction, and a traffic light (TL) controller. The TL control system consists of a local controller and a priority controller on each junction, and a global supervisor. Each local controller aims to minimize the traffic queues and equalize queue lengths across a junction's approaches. When an emergency vehicle enters the system, it notifies the global controller, which calculates the shortest path (in terms of waiting time) for an emergency vehicle to take. It then notifies all of the local junction controllers on the path of the time at which an emergency vehicle is estimated to reach them. Based on this information, the local priority controller can either extend the current green signal or shorten future red signals, to ensure an approach with an emergency vehicle receives a green light. In this publication traffic light controllers act independently and do not cooperate with their neighbours, therefore not accounting for potential agent dependencies.

Richter, S. (2006). “Learning traffic control—towards practical traffic control using policy gradients”, Tech. rep., Albert-Ludwigs-Universitat Freiburg discloses using a reinforcement learning (RL) algorithm to optimize average vehicle travel time. Each intersection implements an RL process that receives a reward based on the number of vehicles it allows to proceed. TL agents communicate with their immediate neighbours, in order to use neighbours traffic counts to anticipate their own traffic flows. This work does not address multiple traffic policies but rather is focused on optimizing global traffic flow and does not learn the dependencies between agents' performances.

A number of existing patent publications attempt to address the use of Q-learning in optimizing the traffic flow, for example US 7047224 B, assigned to Siemans, WO 01/86610 A, assigned to Siemans and DE 4436339 A, assigned to IFU GMBH. However, these patent publications do not address the issue of balancing the multiple policies that traffic systems need to implement, nor the issue of learning the dependencies between the performance of different policies, the dependencies between different junctions, or the degree of agent collaboration required to address these dependencies. Japanese Patent publication number JP 09160605 A, assigned to Omron, addresses the issue of traffic lights exchanging their status, however, it does not address how the information exchanged is used in the presence of multiple policies or if and how is it used to address learning the dependencies between multiple policies, multiple junctions, or learning of suitable degrees of cooperation between junctions.

Salkham (2008) in the paper “A collaborative reinforcement learning approach to urban traffic control optimization”, IAT 2008, 560-566. also addresses the issue of junctions exchanging their status and Q-learning parameters, however, the exchanged messages are used only for collaborative optimization towards a single system policy.

In the work published by Humphrys in 1995 titled “W-learning: competition among selfish Q-learners”, use of W-learning and Q-learning for optimization of multiple policies has been discussed, however the work addresses only a single agent and therefore does not address any of the multi-agent issues (dependencies or degree of collaboration arising), nor it is applied in a traffic control setting.

Single-policy multi-agent approaches, as well as multi-policy single-agent approaches, have limited use in real-world application, and in urban traffic control in particular, as the systems consist of multiple, often hundreds of traffic lights (agents) and the traffic lights need to deal with multiple policies, e.g., optimization of global traffic flow, honouring pedestrian requests, prioritizing public transport vehicles, or prioritize emergency vehicles. Learning and exchange of status techniques from single-policy multi-agent Q-learning approaches are not easily applicable to multiple policies, and require new approaches and techniques when multiple heterogeneous, potentially conflicting, policies are present. Due to the nature of Q-learning, the suitability of actions is learnt specific to given state-action pairs; Q-learning processes implementing different policies will not have matching state-action pairs therefore rendering exchange of status useless as receiving agents will not be capable of interpreting that information or using it for collaboration or optimization.

Similarly, techniques from multi-policy single-agent learning (W-learning) are not easily applicable to multiple agents and require new approaches and techniques when multiple heterogeneous agents are present. Due to the nature of W-learning, the importance of an action is learnt specific to a policy state, and different agents implementing different policies will not have matching policy states, therefore rendering exchange of status useless as receiving agents will not be capable of interpreting that information or using it for collaboration or optimization.

In summary, existing traffic control systems suffer from a number of problems in that they are relatively unsophisticated, and even though they provide a degree of adaptivity, they require a large amount of configuration and manual intervention, and rely on a limited number of, often unreliable sensors, such as induction loops. Furthermore, many of the proposed UTC systems focus on optimization of traffic only towards a single traffic policy (e.g., only optimizing general traffic flow without prioritizing public transport) and do not learn the effect that neighbouring junctions have on one another but tend to cooperate and exchange status with a predefined set of neighbouring junctions, regardless of the degree of influence that the junctions might have on one another.

An object of the present invention is to provide an urban traffic control system and method to overcome at least one of the above mentioned problems and shortcomings of existing prior art systems.

### SUMMARY OF THE INVENTION

According to the present invention there is provided, as set out in the appended claims, a system of agents for use in an Urban Traffic Control environment, each agent representing a traffic light controller at a traffic junction to control traffic flow, said system comprising:
each agent is adapted to collect data local to the junction using one or more sensors and applying a Q-learning reinforcement learning model to said collected data, one Q-learning model per each policy that the agent is implementing;
each agent comprises:
   means for mapping locally collected data to one or more system-state representations available to determine action values;
   means to learn a current importance value of an action relative to actions preferred by other policies on an agent, using a W-Learning model, and determine the dependencies between locally implemented policies;
   means for sharing Q-learning and W-learning parameters, for example, current system-state representations, environment feedback, action values and associated importance values with neighbouring agents, one-hop from each neighbouring agent;
   means to receive and interpret the shared values to remotely learn preferences of policies implemented by other agents, and their relative importance, to learn the dependencies between the policies implemented locally and those implemented by neighbouring agents; and
   means to combine local action-effectiveness and importance values with action-effectiveness and importance values of one-hop neighbouring agents in a periodic manner over a number of time steps to optimise the traffic flow at each agent, taking into account neighbour agents preferred actions and importance values, at each time step.

In one embodiment the exchanged values used to learn preferences of policies implemented by other agents comprises means for using remote policy learning.

In one embodiment there is provided means to determine a cooperation coefficient using a learning model and using said cooperation coefficient to scale action preferences of neighbour agents so as to maximize the performance locally and in the immediate agent neighbourhood.

The main operational advantage of the system of the invention is that it utilizes machine learning to learn appropriate behaviours for a variety of traffic conditions, in a fully decentralized distributed self-organizing approach where data collection and analysis is performed by the junctions or intersections locally. It removes the need for extensive pre-configuration, as the agents or nodes can configure themselves based on the observed conditions and learnt behaviours, reducing the configuration, deployment, and operational time and costs. It also enables timely analysis of large amounts of sensor data and determination of the current traffic conditions to deploy learnt optimal signal sequences for that given set of conditions. Using remote learning, each junction can automatically learn dependencies between neighbouring junctions, i.e., the effect of one junction's traffic light settings on another for a particular set of traffic conditions, removing the need for manual analysis, as well as learning when and how much should junctions take into account neighbouring junctions' preferences when selecting signal settings, by using cooperation coefficient learning.

The invention provides a system and method for supporting simultaneous optimization on multiple junctions towards multiple performance policies, which enable junctions to learn the dependencies between their own performance and the performance of other junctions, and enable junctions to learn to what degree they should collaborate with other junctions to ensure optimal system performance. The system and method makes use of remote policies, which instead of directly using exchanged statuses, enables agents to learn each other's action preferences, and in such a way to enable collaboration.

In one embodiment each junction uses Q-learning and W-learning, together with remote learning and learning of the cooperation coefficients to provide a distributed W-learning model and to obtain said action preferences. Learning can be utilised to learn the most optimal levels of collaboration between multiple agents.

In one embodiment the Q-learning reinforcement learning model receives information on current traffic conditions from at least one sensor, and maps that information to one of the available system-state representations.

In one embodiment the Q-learning reinforcement learning model learns an action to implement the most suitable traffic light sequences in the long-term for the given traffic conditions.

In one embodiment each agent comprises a set of policies such that each junction is adapted to learn a preferred action to be executed, in parallel with the importance of that action depending on the system state using said distributed W-Learning model.

In one embodiment each junction combines local Q-learning and W-learning, with remote learning for neighbouring junctions, to provide a distributed W-learning model in order to obtain said action preferences.

In one embodiment actions are traffic light settings and states can encode any information internally defined as relevant for the decision, e.g., number of cars approaching the junction, or number of buses waiting at approach.

In one embodiment the cooperation coefficient, C, is adapted to enable a local agent to give a varying degree of importance to the neighbours' action preferences, wherein 0<=C<=1.

In one embodiment, at each time step, each local and each remote policy on at least one agent is adapted to decide an action for execution at the next time step, based on the importance of executing that action in the current states of all local and remote policies.

In one embodiment there is provided Q-learning and W-learning data of neighbouring junctions, to obtain data necessary for remote learning of the action preferences from the immediate upstream and/or downstream junctions.

In a further embodiment there is provided an agent for use in an Urban Traffic Control environment, said agent representing a traffic-light controller at a traffic junction to control traffic flow, and adapted to collect data local to the junction using one or more sensors and applying a Q-learning reinforcement learning model to said collected data, one Q-learning model per each policy that the agent is implementing;
each agent comprises:
   means for mapping locally collected data to one or more system state representations available to determine action values;
   means to learn a current importance value of an action relative to actions preferred by other policies on an agent, using a W-Learning model, and determine the dependencies between locally implemented policies;
   means for sharing Q-learning and W-learning parameters, for example current system state representations, environment feedback, action values and associated importance values with neighbouring agents, one-hop from each neighbouring agent;
   means to receive and interpret the shared values to remotely learn preferences of policies implemented by other agents, and their relative importance, to learn the dependencies between the policies implemented locally and those implemented by neighbouring agents; and
   means to combine local action-effectiveness and importance values with action-effectiveness and importance values of one-hop neighbouring agents in a periodic manner over a number of time steps to optimise the traffic flow at each agent, taking into account neighbour agents preferred actions and importance values, at each time step.

In another embodiment there is provided a method for controlling an Urban Traffic Control environment comprising a plurality of agents, each agent representing a traffic light controller at a traffic junction to control traffic flow, the method comprising the steps of:
collecting data local to the junction using one or more sensors and applying a Q-learning reinforcement learning model to said collected data;
mapping locally collected data to one or more system state representations available to determine action values;
determining a current importance value of an action value using a W-Learning model;
sharing action values, rewards values and associated importance values with neighbouring agents, one-hop from each neighbouring agent;
utilizing shared values using remote learning to determine actions preferred by each neighbouring agent; and combining local action-effectiveness and importance values with action-effectiveness and importance values of one-hop neighbouring agents in a periodic manner over a number of time steps to optimise the traffic flow at each agent, taking into account neighbour agents preferred actions and importance values, at each time step.

There is also provided a computer program comprising program instructions for causing a computer program to carry out the above method which may be embodied on a recording medium, carrier signal or read-only memory.

### BRIEF DESCRIPTION OF THE DRAWINGS

The invention will be more clearly understood from the following description of an embodiment thereof, given by way of example only, with reference to the accompanying drawings, in which:—

FIG. 1 illustrates an overall architecture of the system showing a group of traffic control signals at connected intersections each controlled by a single agent;

FIG. 2 illustrates agent interaction required for a decision making process on a single distributed W-Learning (DWL) agent for action selection;

FIG. 3 illustrates an implementation of the DWL action-selection process on a single agent, according to one aspect of the invention; and

FIGS. 4, 5 and 6 illustrate the implementation of the learning process that each DWL agent performs to determine the most suitable cooperation coefficient (C), according to other aspects of the invention.

### DETAILED DESCRIPTION OF THE DRAWINGS/OPERATION

The invention provides a fully self-organizing Urban Traffic Control (UTC) system that uses reinforcement learning (RL) to map the currently-observed traffic conditions (based on the information received from the available road and/or in-car sensor technology) to appropriate traffic light sequences. Such a UTC system is enabled through use of a novel multi-policy multi-agent optimization algorithm, Distributed W-Learning (DWL), which is using RL techniques Q-learning and W-learning, remote learning, and cooperation coefficient learning and described in more detail below.

### Distributed W-Learning (DWL)

In DWL, each junction implements a Q-learning RL process model whereby it receives information on current traffic conditions from available sensors, maps that information to one of the available system state representations, and executes the action (set of traffic light sequences) that is has learnt to be the most suitable in the long-term for the given traffic conditions. For each of the policies (e.g. prioritizing public transport, optimizing general traffic flow), a DWL agent/junction learns a preferred action to be executed, as well as the importance of that action in its current system state. For example, for a policy that prioritizes public transport, action importance is high if it has two buses queuing on its approaches with both of them being behind schedule, while it has a very low importance if there are no public transport vehicles approaching. The importance of the action to a policy is learnt using W-Learning process model.

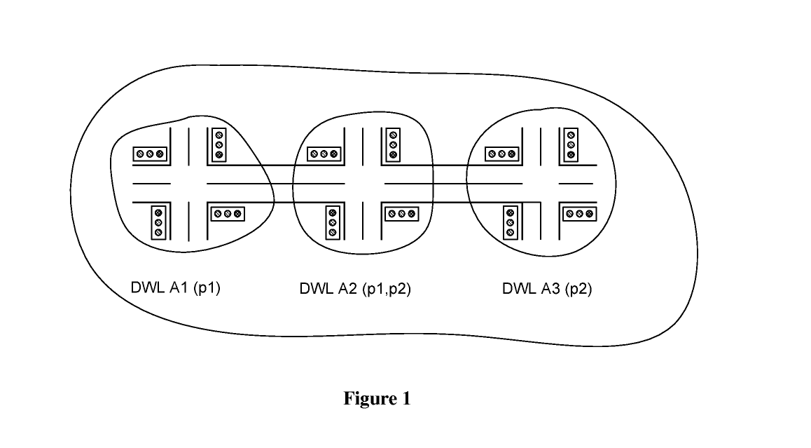

Referring now to the figures and initially FIG. 1, FIG. 1 shows the overall architecture of the system. A group of traffic control signals at connected intersections are each controlled by a single agent implementing DWL. The overall system consists of a group of such junctions, each junction hereinafter referred to as an agent. Each agent is implementing a DWL process to learn and execute the most suitable actions for its own performance goals/policies as well as the goals/policies of neighbouring (all upstream and all downstream) agents. For example, in FIG. 1, DWL agent A1 implements policy p1 (e.g., optimize general traffic flow), DWL agent A2 implements policies p1 (it is also optimizing general traffic flow) and p2 (e.g., prioritize buses) and DWL agent A3 also implements policy p2 (it is also prioritizing buses). Using DWL, A2 learns the best local traffic-control signal settings to meet its performance policies p1 and p2, but also, in collaboration with A1 and A3, learns the best local settings to enable A1 and A3 to meet their performance policies p1, p2 locally. The division into agents can also be physical, i.e., the software that implements DWL behaviours can be running on the traffic-control signals themselves, but all software agents can also be running in the same central location.

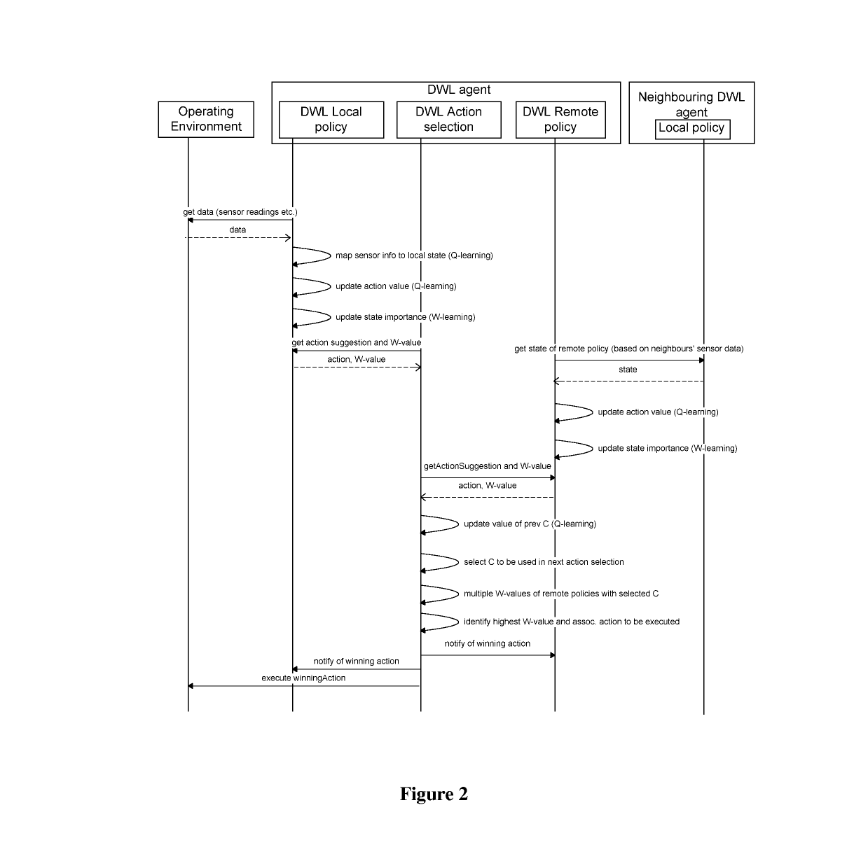

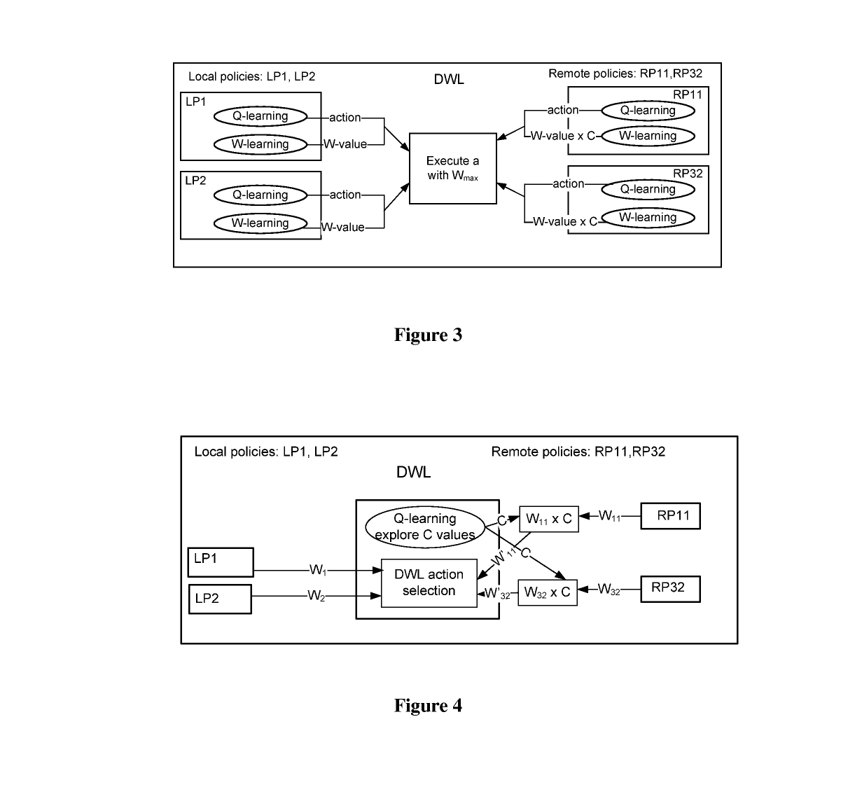

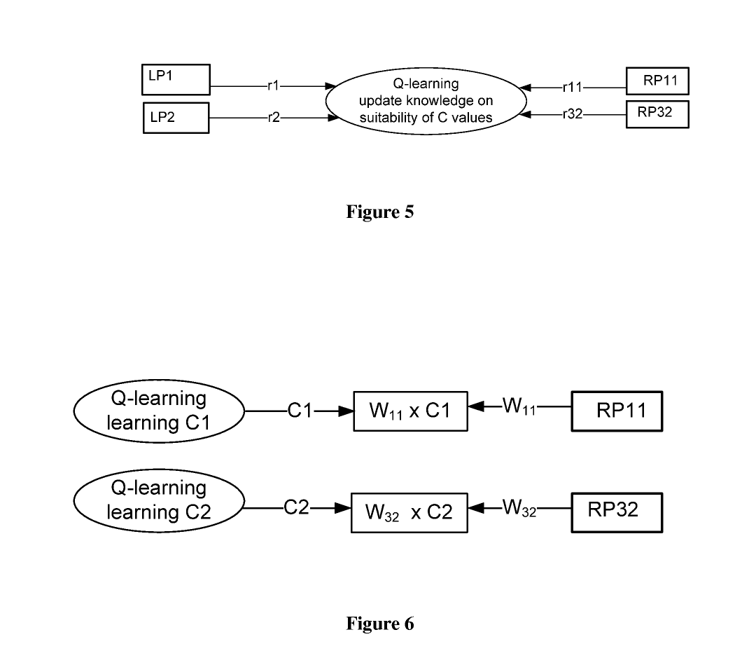

FIG. 2 depicts the agent interaction required for a decision making process on a single DWL agent. Each agent in the system, at each time step, performs interaction as described in FIG. 2 with each of its neighbouring agents, for each of its local policies and for each of its neighbours' policies. At system initialization, each agent exchanges with its neighbours a list of its local policies and associated states. Each agent initiates its remote policies which perform remote learning, one policy for each corresponding local policy of each of its neighbours. After initialization, at each time step (depicted in FIG. 2), each local policy on each agent observes its local environmental conditions, maps them to a state representation, and performs updates on its local processes that learn the optimal actions and the importance of executing the preferred actions in each state. Each local policy suggests an action for execution at the next time step, together with the associated W-value (importance) of the policy's current state. Each agent also receives from each of its neighbours' state information (a representation of the neighbours' environment conditions) for each of its policies, and based on that information performs updates on its remote processes that learn the optimal actions and the importance of executing the preferred actions in each particular state. Each remote policy suggests an action for execution at the next time step, together with the associated W-value (importance) for the policy's current state. This decision process is described in more detail in FIG. 3 below. Before making action decisions, each DWL agent also updates its learning process that learns the optimal value of Cooperation Coefficient (C) for the neighbourhood, i.e., for all its local and remote policies. This step is optional, as agents can either use predefined C, or learn C during the system operation. The process of learning C is described in more detail in FIG. 4.

FIG. 3 depicts the implementation of the DWL action-decision process on a single agent, according to one aspect of the invention. FIG. 3 shows an agent A2, with its local policies p1 and p2. A2 has 2 neighbouring junctions, A1, which implements policy p1, and A3, which implements policy p2. Therefore, agent A2 learns how to best meet its local policies p1 and p2 (lp1, lp2), but also learns how to best help neighbours meet their policies, or so-called remote policies, rp11 (policy p1 on agent A1) and rp32 (policy p2 on agent A3). At each time step, each agent makes a decision as to what actions to execute (i.e., what traffic-control signal settings to deploy) based on optimal actions learnt for its local and remote policies. Each policy, both local and remote, suggests an action, as selected based on the outcome of the ongoing Q-learning processes associated with each policy. Each action is also associated with its current importance, expressed as a learnt W-value, learnt as the outcome of the ongoing W-learning processes associated with each policy. The action that is executed on each agent is the one with the highest current importance, i.e., the highest W-value, after remote policies' W-values have been multiplied by the cooperation coefficient C, where 0<=C<=1. C is introduced to enable a local agent to give a varying degree of importance to the neighbours' action preferences. C can range from a fully non-cooperative value, C=0, where an agent does not consider neighbours' action preferences at all, to a fully cooperative, C=1, where neighbours' preferences matter as much as local ones. C can be predefined or can be learnt at runtime, using a learning process which aims to maximize the rewards received on all agent's local and remote policies.

FIGS. 4, 5, and 6 illustrate the implementation of the learning process that each DWL agent performs to learn the most suitable cooperation coefficient (C). C enables agents to take into account action preferences of their neighbours' policies with varying weight, which can be equal to or less than their local action preferences.

At each time step, each local and each remote learning policy on a DWL agent suggest an action for execution at the next time step, together with an associated W-value, representing the importance of executing that action in the policy's current state. An agent takes the suggestions of its local policies with their full weight, but it has the option to scale the weight of remote policy suggestions (i.e., actions suitable for its neighbours) in order to give higher priority to its local preferences. Using different scaling on different agents in the system can be beneficial, in order to, for example, enable junctions that are more important for the overall system performance to take only their local preferences into account (i.e., use C=0), or to enable less important junctions to execute actions suitable for their more important neighbours. Therefore, each DWL agent is enabled to learn or determine the most suitable value of C, so that resulting behaviour is optimal for the neighbourhood, i.e., for an agent itself and for all the policies that all of its one-hop neighbours are implementing. Determining C is implemented as a learning process on each agent. The set of actions in that learning process consists of various values of C, e.g., {C=O, C=0.1, C=0.2, C=0.3, C=0.4, C=0.5, C=0.6, C=0.7, C=0.8, C=0.9, C=1}. At each time step, a learning process selects one of the C values and the agent multiplies all W-values received from remote policies with that value, for example as shown in FIG. 4.

FIG. 5 shows the action associated with the state with the highest current W-value is executed, and the outcome of that action is observed on all local policies and on all policies on all one-hop neighbours, i.e., the rewards received by all local policies and by all policies on all one-hop neighbours are added up and used to update the value of C used in the last time step using a learning process.

FIG. 6 illustrates how the value of C can be learnt per agent, i.e., an agent uses the same C to scale W-values received for all policies on all one-hop neighbours; can be learnt per agent pair, i.e., an agent has as many Q-learning processes as it has neighbours, and learns a separate C to scale W-values received from each neighbour; or can be learnt per remote policy, i.e., the number of Q-learning processes that are learning C on an agent is the sum of the number of all policies that all of its one-hop neighbours implement, agent learns a separate C to scale W-values received from each policy on each neighbour. FIG. 4 shows an example where a single C is learnt on an agent, and FIG. 6 shows an example where a different C is learnt for each remote policy.

It will be appreciated that the DWL technique according to the invention combines local Q-learning and W-learning, with remote learning for its neighbouring junctions, to obtain action preferences not just from its local policies, but also from the immediate upstream and downstream junctions. Each agent can be adapted to obtain action preferences from all of its one-hop neighbours, for example from neighbours multiple hops away or only from a subset of one-hop or multi-hop neighbours. It is envisaged that agents can be adapted to collaborate with only downstream or only upstream neighbours, depending on the application required.

In this way, junctions coordinate with their upstream and downstream neighbours to execute actions that are most appropriate for the traffic conditions not just locally, but for the immediate neighbourhood as well. The priority of different policies is easily incorporated into DWL, as if a policy is given a higher reward in the RL process design, it will have a higher importance compared to a lower-priority policy, enabling easy integration of public vehicle and emergency vehicle priority in a UTC system.

In order to enable an agent to decide whether to execute an action preferred by its local policies or by its neighbours' policies, DWL includes the cooperation coefficient C. C has a value between 0 and 1, where 0 denotes a non-collaborative junction, i.e., a junction that always executes an action preferred by its local policies, and 1 denotes a fully collaborative junction, i.e., a junction that gives as much weight to neighbours' preferences as to its local preferences when making an action decision. C can be predefined (to make particular junctions more/less cooperative based on their importance in the system) or can be learnt by each junction so as to maximize the reinforcement learning reward locally and in its one-hop neighbourhood.

In one embodiment the system can function as follows, each junction/agent implements a Q-learning reinforcement learning process whereby it receives information on current traffic conditions from available sensors. This information is then mapped to one of the available system state representations, and an action is executed (set of traffic light sequences) that is has learnt to be the most suitable in the long-term for the given traffic conditions.

For each of a set of policies (e.g. prioritizing public transport, optimizing general traffic flow), a junction/agent learns a preferred action to be executed, as well as the importance of that action in its current system state using W-Learning.

The overall operation of this embodiment can be summarised in that Distributed W-Learning combines local Q-learning and W-learning, with remote learning on behalf of its neighbouring junctions/agents, and learning of cooperation coefficients, to obtain action preferences not just from its local policies, but also from all its one-hop neighbours, in order to improve traffic flow efficiency.

It will be appreciated that the present invention allows increasingly available road-side and in-car sensor technology, as well as car-to-infrastructure and car-to-car communication capabilities to be utilized to enable UTC systems to make more informed, quicker adaptation decisions. In particular, by using UTC systems based on distributed w-learning, performance is increased and response time to changing traffic conditions is decreased, as well as a reduction in operating costs in traffic control centres, including both human and hardware cost. In addition, by using UTC systems based on remote learning and cooperation coefficient learning, junctions are capable of learning the dependencies between each other's performance and capable of collaboration to help improve not just their own, but each other's performance, and therefore performance of the overall system.

The embodiments in the invention described with reference to the drawings comprise a computer apparatus and/or processes performed in a computer apparatus to control each agent according to the invention. However, the invention also extends to computer programs, particularly computer programs stored on or in a carrier adapted to bring the invention into practice and for controlling the agent. The program may be in the form of source code, object code, or a code intermediate between source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa. In addition the ‘agent’ hereinbefore described with respect to the invention can be incorporated in an existing junction node or new junction node in hardware or software or a combination of both. The invention is not limited to the embodiments hereinbefore described but may be varied in both construction and detail.

1. A system of agents for use in an Urban Traffic Control environment, each agent representing a traffic light controller at a traffic junction to control traffic flow, said system comprising:
each agent is adapted to collect data local to the junction using one or more sensors and applying a Q-learning reinforcement learning model to said collected data, one Q-learning model per each policy that the agent is implementing;
each agent comprises:
means for mapping locally collected data to one or more system state representations available to determine action values;
means to learn a current importance value of an action relative to actions preferred by other policies on an agent, using a W-Learning model, and determine the dependencies between locally implemented policies;
means for sharing Q-learning and W-learning parameters, for example current system state representations, environment feedback, action values and associated importance values with neighbouring agents, one-hop from each neighbouring agent;
means to receive and interpret the shared values to remotely learn preferences of policies implemented by other agents, and their relative importance, to learn the dependencies between the policies implemented locally and those implemented by neighbouring agents; and
means to combine local action-effectiveness and importance values with action-effectiveness and importance values of one-hop neighbouring agents in a periodic manner over a number of time steps to optimise the traffic flow at each agent, taking into account neighbour agents preferred actions and importance values, at each time step.

2. The system as claimed in claim 1 wherein the exchanged values to learn preferences of policies implemented by other agents comprise means for using remote policy learning.

3. The system as claimed in claims 1 comprising means to determine a cooperation coefficient using a learning model and using said cooperation coefficient to scale action preferences of neighbour agents so as to maximize the performance locally and in the immediate agent neighbourhood.

4. The system as claimed in claim 3 wherein the cooperation coefficient, C, is adapted to enable a local agent to give a varying degree of importance to the neighbours' action preferences, wherein 0<=C<=1.

5. The system as claimed in claim 1 wherein each junction combines local Q-learning and W-learning, with remote learning for neighbouring junctions, to provide a distributed W-learning model in order to obtain said action preferences.

6. The system as claimed in claim 1 wherein the Q-learning reinforcement learning model receives information on current traffic conditions from at least one sensor, and adapted to map that information to one of the available system-state representations.

7. The system as claimed in claim 1 wherein the learning model executes an action to implement the most suitable traffic-light sequences in the long-term for the given traffic conditions.

8. The system as claimed in claim 1 wherein each agent comprises a set of policies such that each junction is adapted to learn a preferred action to be executed, in parallel with the importance of that action in its current system state using said W-Learning model.

9. The system as claimed in claim 1 wherein each junction combines local Q-learning and W-learning with remote learning on behalf of its neighbouring junctions/agents, and learning of cooperation coefficients, to provide a distributed W-learning model, to obtain said action preferences.

10. The system as claimed in claim 1, wherein actions are traffic light settings and states can encode any information internally defined as relevant for the decision, for example, number of cars approaching the junction or number of buses waiting at an approach.

11. The system as claimed in claim 1 wherein at each time step, each local and each remote policy on at least one agent is adapted to decide an action for execution at the next time step, based on the importance of executing that action in the policy's current state.

12. The system as claimed in claim 1 wherein Q-learning and W-learning data of neighbouring junctions are exchanged, to obtain action preferences from the immediate upstream and/or downstream junctions.

13. An agent for use in an Urban Traffic Control environment adapted for incorporation into the system as claimed in claim 1.

14. A method of controlling a system of agents for use in an Urban Traffic Control environment, each agent representing a traffic light controller at a traffic junction to control traffic flow, said method comprising the steps of:
collecting at each agent data local to the junction using one or more sensors and applying a Q-learning reinforcement learning model to said collected data, one Q-learning model per each policy that the agent is implementing;
mapping at each agent locally collected data to one or more system-state representations available to determine action values;
learning at each agent a current importance value of an action relative to actions preferred by other policies on an agent, using a W-Learning model, and determine the dependencies between locally implemented policies;
sharing at each agent Q-learning and W-learning parameters, for example current system-state representations, environment feedback, action values and associated importance values with neighbouring agents, one-hop from each neighbouring agent;
receiving and interpreting the shared values to learn preferences of policies implemented by other agents, and their relative importance, to learn the dependencies between the policies implemented locally and those implemented by neighbouring agents; and
combining local action-effectiveness and importance values with action-effectiveness and importance values of one-hop neighbouring agents in a periodic manner over a number of time steps to optimise the traffic flow at each agent, taking into account neighbour agents preferred actions and importance values, at each time step.
